(19) United States
(12) Patent Application Publication
(10) Pub. No.: US 2013/0146769 A1
(43) Pub. Date: Jun. 13, 2013

(54) OPTICAL PULSE GENERATING APPARATUS, TERAHERTZ SPECTROSCOPY APPARATUS, AND TOMOGRAPHY APPARATUS

(71) Applicant: Toshihiko Ouchi, Machida-shi (JP)

(72) Inventor: Toshihiko Ouchi, Machida-shi (JP)

(73) Assignee: CANON KABUSHIKI KAISHA, Tokyo (JP)

(21) Appl. No.: 13/818,607

(22) PCT Filed: Jul. 26, 2011
(86) PCT No.: PCT/JP2011/067576

§ 371 Date: Feb. 22, 2013

(30) Foreign Application Priority Data
Aug. 27, 2010 (JP) 2010-191321

(51) Int. Cl. G01N 21/17

(52) U.S. Cl. CPC G01N 21/17
USPC 250/338.1; 359/245; 359/285; 359/238

(57) ABSTRACT

An optical pulse generating apparatus that supplies pump light and probe light includes a light source and a modulation unit configured to modulate light emitted from the light source, thereby dividing the light into the pump light and the probe light. The modulation unit is configured such that a frequency for modulating the light is variable. The modulation unit changes a difference between a moment of the pump light incident on an object and a moment of the probe light incident on the object by changing the frequency.

### TECHNICAL FIELD

The present invention relates to an optical pulse generating apparatus, a terahertz spectroscopy apparatus, and a tomography apparatus.

### BACKGROUND ART

In recent years, a non-destructive sensing technique in which terahertz waves (frequencies of 30 GHz to 30 THz) are used have been developed. As the applied fields of terahertz waves, a technique in which imaging is performed with a transparent inspection apparatus, a spectroscopic technique in which physical properties such as the binding state of molecules are checked by obtaining an absorption spectrum or a complex permittivity, a measuring technique in which physical properties such as the density or the mobility of carriers or the conductivity is checked, and an analysis technique for biomolecules have been developed.

A terahertz time-domain spectroscopy apparatus in which terahertz pulses are used, which is a representative technique, has an optical system in which femtosecond laser is divided into two types of light, which are radiated onto a terahertz generating element as pump light and onto a terahertz detecting element as probe light, respectively. By changing the difference between moments at which the pump light and the probe light are radiated, terahertz pulses are measured through sampling to analyze a change caused by interaction with an object.

As a method for adjusting the time difference, a mechanical delay stage is generally used. However, there has been a problem in that vibration acts as noise and the time taken to obtain a signal cannot be shortened because the time to be adjusted is of the order of milliseconds. Therefore, an asynchronous sampling method in which two types of fiber lasers that have been synchronized by phase lock loop (PLL) control are used as the pump light and the probe light, respectively, and the phase difference in the PLL is variable is attracting attention as a high-speed optical delay method (PTL 1).

### CITATION LIST

### Patent Literature

PTL 1 Japanese Patent Laid-Open No. 2010-2218

### SUMMARY OF INVENTION

### Technical Problem

However, in the case of the method according to PTL 1, since two lasers are used, cost is large, which has been a problem.

Therefore, the present invention provides an optical pulse generating apparatus that has a simple structure and with which the time difference between the pump light and the probe light can be changed at high speed.

### Solution to Problem

According to an aspect of the present invention, an optical pulse generating apparatus that supplies pump light and probe light includes a light source and a modulation unit configured to modulate light emitted from the light source, thereby dividing the light into the pump light and the probe light. The modulation unit is configured such that a frequency for modulating the light is variable. The modulation unit changes a difference between a moment of the pump light incident on an object and a moment of the probe light incident on the object by changing the frequency.

Other aspects of the present invention will be clarified by the exemplary embodiments that will be described below.

### Advantageous Effects of Invention

An optical pulse generating apparatus can be provided that has a simple structure and with which the time difference between the pump light and the probe light can be changed at high speed.

### BRIEF DESCRIPTION OF DRAWINGS

FIG. 1 is a diagram illustrating an optical pulse generating apparatus according to a first embodiment of the present invention.

FIG. 2 is a diagram illustrating a modulator according to the first embodiment of the present invention.

FIG. 3 is a diagram for explaining optical pulse delay in the present invention.

FIG. 4 is a diagram illustrating a terahertz tomography apparatus according to the first embodiment of the present invention.

FIG. 5 is a diagram illustrating an optical pulse generating apparatus according to a second embodiment of the present invention.

FIG. 6 is a diagram illustrating an optical pulse generating apparatus according to a third embodiment of the present invention.

FIG. 7 is a diagram illustrating an optical pulse generating apparatus according to a fourth embodiment of the present invention.

FIG. 8A is a diagram illustrating a cross-sectional image obtained by the terahertz tomography apparatus.

FIG. 8B is a diagram illustrating a time waveform obtained by the terahertz tomography apparatus.

### DESCRIPTION OF EMBODIMENTS

### First Embodiment

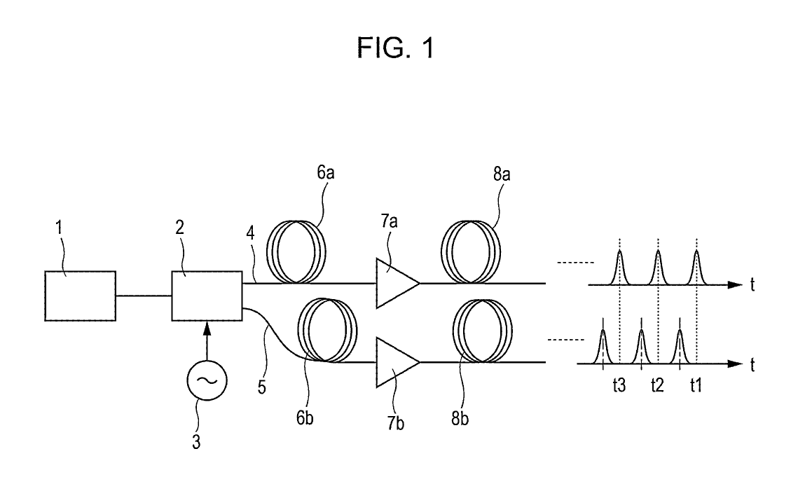

An optical pulse generating apparatus that supplies pump light and probe light for asynchronous sampling according to an embodiment of the present invention will be described with reference to FIG. 1. The optical pulse generating apparatus according to this embodiment has a light source 1 and modulation units 2 and 3. As the light source 1, a continuous-wave laser in a single mode, which is, for example, a laser diode (LD) is used. Instead of the LD, a solid-state laser such as YAG (yttrium-aluminum-garnet) laser, a fiber laser, or the like may be used. The modulation units 2 and 3 are a modulator 2 and an external power source 3, and periodically modulate light emitted from the light source 1 to divide the light into the pump light and the probe light. The modulator 2 is an electro-optical (EO) modulator, which is, for example, a Mach-Zehnder modulator (MZM), and converts the light emitted from the light source 1 into an optical pulse string by performing binary modulation. The external power source 3 includes, for example, a synthesizer and an amplifier and can perform on-off keying on the MZM because a frequency to be modulated is variable. The frequency to be modulated can be typically changed within a range of about 1 GHz to 10 GHz.

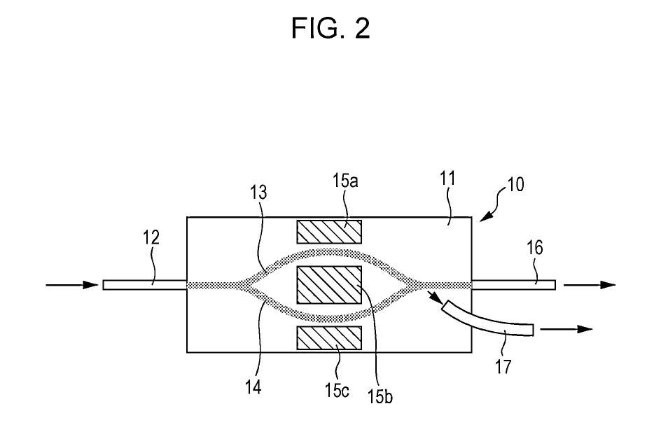

The MZM generally has a structure 10 illustrated in FIG. 2. The MZM includes an electro-optical crystalline substrate 11 composed of lithium niobate (LiNbOₓ: LN) or the like, an optical input fiber 12 that receives light from the LD, optical waveguides 13 and 14 provided in the electro-optical crystalline substrate 11 in the shape of Y-branches, modulating electrodes 15a to 15c, and optical output fibers 16 and 17. This is a known structure of an MZM. When the voltage applied between electrodes from the external power source 3 is V₀ (modulating signal is on), light is output to the optical output fiber 16, and when the voltage is V₁ (modulating signal is off), light is output to the optical output fiber 17. That is, when light passing through the optical waveguide 13 and light passing through the optical waveguide 14 that are in phase are combined, the resulting light is output to the optical output fiber 16, and when light passing through the optical waveguide 13 and light passing through the optical waveguide 14 that have the opposite phases are combined, the resulting light is output to the optical output fiber 17. Therefore, the phases of the optical outputs of the optical output fibers 16 and 17 are opposite to each other in terms of time. Such a modulation technique is common when the modulation technique is adopted for a light source for optical communication. A known technique may be used for high-speed modulation of GHz order or drift control. The optical output fiber 16 is connected to a fiber 4, and the optical output fiber 17 is connected to fiber 5. In the case of recurring pulses, as in pulse waveforms illustrated in FIG. 1, pulses output from the fiber 5 can be set in positions complementary to those of pulses output from the fiber 4 at points of time t1, t2, and t3 (intermediate positions of pulse strings). Therefore, there is a certain phase difference between the two types of pulses.

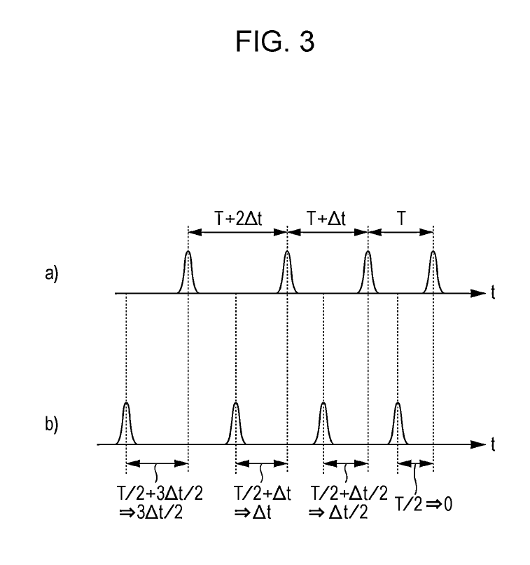

At this time, when a frequency (modulation frequency) fm of the external power source 3 is changed, the intervals between pulses are accordingly changed. However, since the two types of pulses that have opposite phases are output after being modulated by the same power supply, the pulses output to the optical output fibers 16 and 17 (fibers 4 and 5) still have a particular phase relationship. The mechanism will be described with reference to FIG. 3. “a)” illustrates pump pulses, and “b)” illustrates probe pulses. If the intervals between the pump pulses are changed from T to T+Δt, and then to T+2Δt, the time difference from a nearest probe pulse changes from T/2 to T/2+Δt/2, T/2+Δt, and then to T/2+3Δt/2. If the time T/2, which corresponds to the initial phase difference that exists between the two types of pulses from the beginning, can be reduced to 0 by providing a difference in the travel distance, the time difference between the pump pulses and the probe pulses can be changed from Δt/2 to Δt, 3Δt/2, and so on. For example, if a modulation frequency of 10 GHz is taken as a base frequency, the period is 100 ps. If the period is changed to 101 ps, 102 ps, 103 ps, and so on, the time difference between the pump pulses and the probe pulses changes from 0 to 0.5 ps, 1 ps, 1.5 ps, and so on. In addition, in order to cancel the time difference of 100/2=50 ps as the adjustment of the initial phase, the travel distance of the pump light may be increased by 50 ps×3E+8 m/s=1.5 cm (or 1 cm, if the optical fiber has an index of refraction of 1.5). It is to be noted that, in FIG. 3, although a case in which the intervals change upon each pulse is illustrated in order to clearly explain the time difference between the pump pulses and the probe pulses, the period corresponding to the modulation frequency fm in practice is typically shorter than a period of time by which the modulation frequency fm is changed. In that case, the intervals remain the same over a plurality of pulses, and then change when a certain number of pulses have been output.

Now, the description returns to FIG. 1. In the two optical outputs of the MZM, the bandwidths are such that pulses have been subjected to wavelength chirping. The waveforms of the pulses are shaped by first and second single mode fibers (SMFs) 6a and 6b, and the optical outputs are amplified by first and second optical amplifiers 7a and 7b such as fiber amplifiers. The pulses are then compressed by first and second dispersion compensation units 8a and 8b. As a result, a pulse width of about 100 fs is typically obtained. Here, the optical output of the optical output fiber 16 is generally larger than that of the optical output fiber 17. Therefore, the configuration of the subsequent stages (SMFs, optical amplifiers, dispersion compensation units) of the MZM may be optimized for each optical output, and the configurations (dispersion values of the fibers, amplification factors, and the like) for the optical outputs may be different from each other. In addition, the pulse widths and the output powers need not necessarily be the same, that is, for example, the output power of the optical output of the first dispersion compensation unit 8a on the pump side may be about 100 mW on average, and the output power of the optical output of the second dispersion compensation unit 8b may be about 10 mW on average.

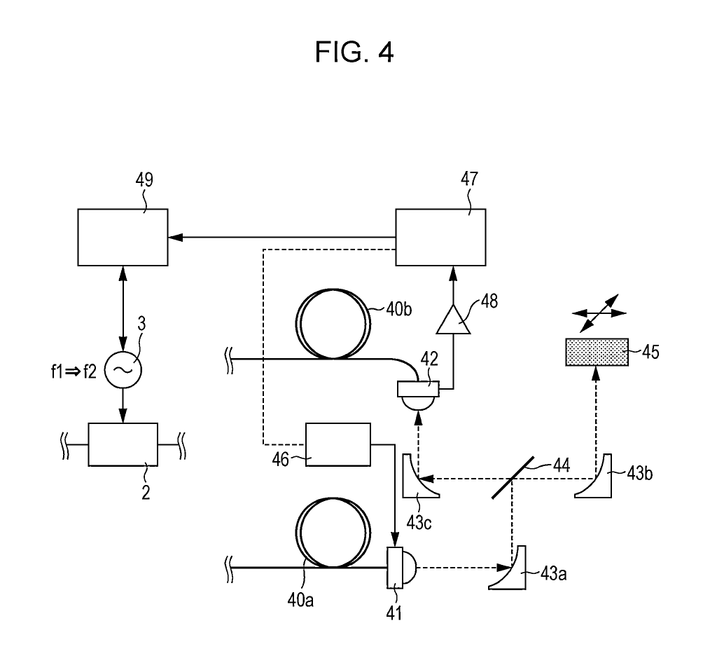

A terahertz time-domain spectroscopy apparatus for which the pump pulses and the probe pulses are used is illustrated in FIG. 4. Dispersion compensation units 40a and 40b correspond to the first and second dispersion compensation units 8a and 8b, respectively, illustrated in FIG. 1 (the positions in the vertical direction are switched in FIG. 4). The optical output of the dispersion compensation unit 40a is radiated onto a terahertz wave generating element 41 for generating a terahertz wave, such as an InGaAs-based photoconductive element. In addition, the optical output of the dispersion compensation unit 40b is radiated onto a terahertz wave detecting element 42 for detecting a terahertz wave, such as, similarly, a photoconductive element.

A terahertz wave generated by the terahertz wave generating element 41 is converted into parallel light by a parabolic mirror 43a and reflected by a half mirror (mesh, Si, or the like) 44. The parallel light is then condensed by a parabolic mirror 43b and radiated onto a measurement sample 45. Arrows illustrated above the measurement sample 45 indicate that the measurement sample 45 is disposed on a stage capable of scanning a sample in a two-dimensional manner. The terahertz wave reflected by the measurement sample 45 is then reflected by the parabolic mirror 43b, and components that pass through the half mirror 44 is condensed by a parabolic mirror 43c and detected by the terahertz wave detecting element 42. Synchronous detection may be performed as necessary by modulating the terahertz wave generating element 41 with a modulation unit 46 and by using a lock-in amplifier in a signal obtaining unit 47, in order to observe a micro-signal at a high signal-to-noise ratio. A detected signal is amplified by an amplifier 48 and propagates through the signal obtaining unit 47. The detected signal can then be observed as the waveform of a terahertz pulse in a data processing/outputting unit 49. However, when the output power of a signal is high, this synchronous detection system (the modulation unit 46 and the lock-in amplifier) may be omitted and the output of the amplifier 48 may be obtained by the signal obtaining unit 47 as it is.

A modulator and an external power supply illustrated in FIG. 4 are the same as the modulator 2 and the external power supply 3 illustrated in FIG. 1, and accordingly the same reference numerals are used therefor. The modulator 2 and the external power source 3 illustrated in FIG. 4 are controlled by the data processing/outputting unit 49 to change the modulation frequency fm from f1 to f2 while synchronizing a signal corresponding to the above-described time difference and obtaining the signal. The waveform of a terahertz pulse is then output. It is to be noted that the wavy lines illustrated in FIG. 4 on both sides of the modulator 2 and one sides of the dispersion compensation units 40a and 40b are used to omit the same part of wiring as in FIG. 1.

In this embodiment, as described above, the time difference between optical pulses to be radiated onto the terahertz wave generating element 41 and the terahertz wave detecting element 42 can be adjusted by changing the modulation frequency of the MZM. Therefore, a terahertz waveform can be obtained at high speed through asynchronous sampling of light. Since a mechanical delay stage is not necessary, noise that would otherwise be caused by vibration is not generated.

It is to be noted that, although an example in which the MZM having a Y-branch structure is used has been described, an EO modulator having two outputs realized by a directional coupler or the like may be used. In addition, although an embodiment in which the pump light and the probe light according to the embodiment of the present invention are used for a terahertz time-domain spectroscopy apparatus has been described, the pump light and the probe light may be used in a pump-probe method by which the physical properties of an object in a relatively high-speed phenomenon (for example, the carrier lifetime in a semiconductor) are measured. In that case, the pump light and the probe light are radiated onto the same region or close regions of an object, with a time difference provided therebetween.

### Example 1

Example 1, which is a specific example of the first embodiment, will be described.

As the light source 1, a distributed feedback laser diode (DFB-LD) that oscillates at 1.53 μm in the single mode is used, and a continuous-wave (CW) operation is performed at 10 mW. The MZM is modulated by a known technique with an initial frequency of 10 GHz. At this time, because wavelength chirping is caused, the SMFs 6a and 6b in the subsequent stages shape pulses such that the wavelength chirping is compensated, thereby providing a pulse width of, for example, several ps. The pulses are then amplified by the first and second optical amplifiers 7a and 7b that include Er-doped fibers and compressed by the first and second dispersion compensation units 8a and 8b that include dispersion-flattened dispersion-decreasing fibers (DF-DDF). The output power and the pulse width of the optical output of the first dispersion compensation unit 8a are adjusted to be 30 mW on average and 150 fs, respectively, and the output power and the pulse width of the optical output of the second dispersion compensation unit 8b are adjusted to be 5 mW on average and 200 fs, respectively.

The pump light and the probe light generated in such a manner are guided to the terahertz wave generating element 41 and the terahertz wave detecting element 42, respectively, illustrated in FIG. 4 and serve for a terahertz tomography apparatus. When the pulse intervals are changed from 100 ps (10 GHz) to 300 ps (3.3 GHz) by changing the modulation frequency of the external power source 3, a time difference of up to 100 ps [Δt/2=(300−100)/2] can be provided. If the period is changed every 0.2 ps stepwise at this time, a total of 1000 pieces of data each obtained every 0.1 ps can be obtained. By obtaining pieces of data repeatedly through stepwise changes in the period for every 0.2 ps within the range of pulse intervals of 100 ps to 300 ps, and then by performing an averaging process on a plurality of pieces of data that have been obtained and that correspond to the same time difference, the signal-to-noise ratio can be improved. Because the speed at which the modulation frequency or the period is changed is instructed by electrical signals, which are transmitted at high speed, the time taken to obtain a waveform is almost solely determined by the time constant of the signal obtaining unit 47. One terahertz waveform can be typically obtained from each observed point of a sample at high speed, namely in the order of milliseconds.

It is to be noted that, because the speed at which the modulation frequency is changed is sufficiently slow (for example, MHz order) relative to the modulation frequency fm of light, the period does not change for every pulse, but changes at, for example, every 1000th pulse as described above.

By analyzing a terahertz pulse reflected from the measurement sample 45 in the system illustrated in FIG. 4, the system can be used as a terahertz spectroscopy apparatus that obtains spectroscopy data using a Fourier transform. In addition, the system can also be used as a tomography apparatus that captures cross-sectional images of the measurement sample 45 by obtaining a plurality of reflecting interfaces of the inner structure of the measurement sample 45.

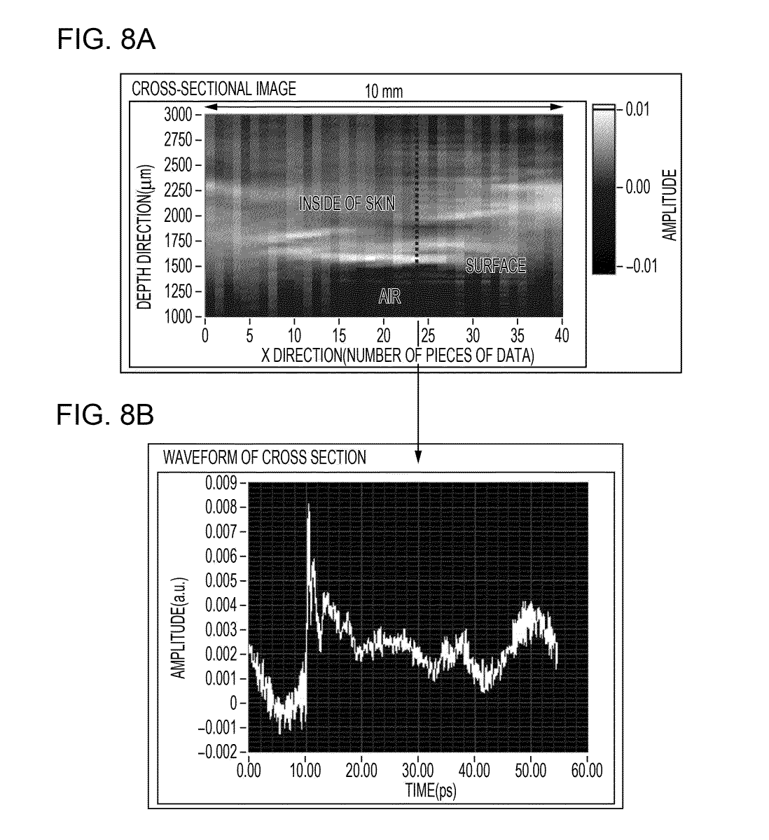

FIG. 8A illustrates an example in which a cross-sectional image of skin is observed using the tomography apparatus. The cross-sectional image is a two-dimensional image having a width of 10 mm and a depth of 3000 μm (1500 μm inside the skin). FIG. 8B illustrates a terahertz time-domain waveform at a position (position indicated by a dotted line in FIG. 8A) of the 23rd point (the horizontal axis has a pitch of 250 μm) in the X direction. Multiple terahertz pulses reflected from a plurality of layer interfaces can be observed. The time taken for this apparatus to obtain the two-dimensional cross-sectional image illustrated in FIG. 8A is calculated as follows: if the time taken to obtain 1 point in the X direction is assumed to be 10 ms, which is the period of time taken for one scan, it takes a total of 100 ms for ten scans on average; and since the measurement sample 45 is scanned for 40 points (width of 10 mm) at a pitch of 250 μm, it takes a total of 4 seconds. However, because there is standby time and the like in practice, it takes a total of about 5 seconds.

### Example 2

In Example 2, which is another specific example of the first embodiment, a second harmonic wave generating (SHG) element (not illustrated) composed of periodically poled lithium niobate (PPLN) or the like is inserted between the fiber output and the terahertz wave generating element 41, in order to improve the signal-to-noise ratio of the terahertz spectroscopy apparatus or the tomography apparatus. In doing so, the output power of optical pulses can be improved and a photoconductive element containing low-temperature-growth GaAs can be used as the terahertz wave detecting element 42.

Because the output power cannot be largely increased with the DF-DDF used in Example 1, a combination between a photonic crystal fiber and a highly nonlinear fiber is used instead. In addition, in order to decrease the pulse width, the Er-doped fiber is designed such that the wavelength bandwidth is increased through linear chirping caused by self-phase modulation. In the output of the SMFs 6a and 6b in the previous stage, not only dispersion compensation but also inverse chirping is performed, so that the amount of chirp is adjusted when the output is amplified by the Er-doped fiber and the wavelength at which self-phase modulation is conspicuously caused. In such a configuration, the pulse width and the output power of the first dispersion compensation unit 8a are controlled in such a way as to be 30 fs and 60 mW, respectively, and those of the second dispersion compensation unit 8b are controlled in such a way as to be 30 fs and 120 mW, respectively. As described above, since the probe light passes through the SHG element, the pulse width and the output power become about 60 fs and 10 mW, respectively, when the probe light reaches the terahertz wave detecting element 42.

In such a system, the pulse width of a terahertz wave decreases to about 300 fs, and the signal strength of the terahertz wave increases. Therefore, the measurement bandwidth extends to about 7 THz, and the time taken for a measurement can be further reduced compared to Example 1.

### Second Embodiment

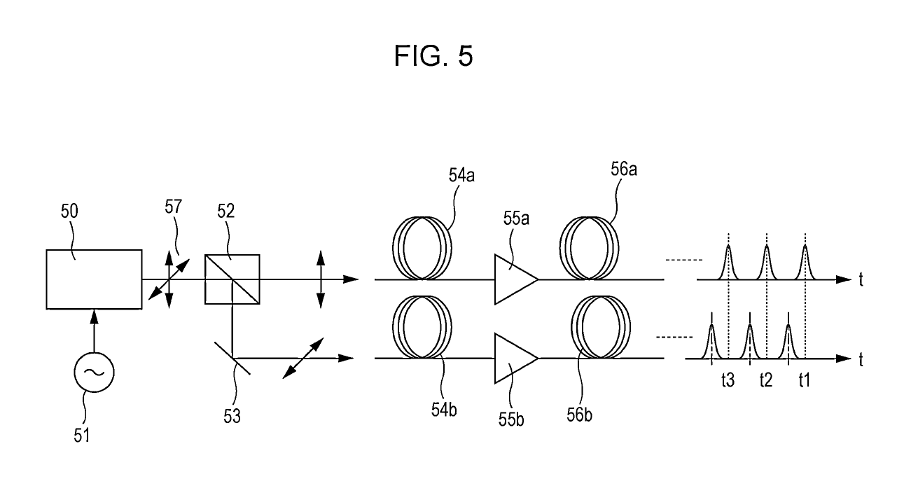

A second embodiment of the present invention is illustrated in FIG. 5. An optical pulse generating apparatus according to this embodiment has a light source 50, a modulation unit 51 that periodically modulates the oscillation state of the light source 50, a dividing unit 52 that divides light emitted from the light source 50 into pump light and probe light, and a mirror 53. As the light source 50, a polarization modulation laser is used. The polarization modulation laser is realized by a fiber laser or a laser diode. As the polarization modulation laser, for example, a transverse electric/transverse magnetic (TE/TM) mode switching laser diode [Appl. Phys. Lett., vol. 67, 3405 (1995) and the like] having a DFB structure may be used. The modulation unit 51 is an external power supply and switches the polarization direction of laser light 57 (oscillation state of the polarization modulation laser 50) by transmitting a signal to the polarization modulation laser 50. As the dividing unit 52, a polarizing beam splitter (PBS) is used.

In this embodiment, in order to output two types of optical pulses having a certain phase difference between each other, the polarization direction of the laser light 57 emitted from the polarization modulation laser 50 is switched by a signal transmitted from the external power supply (modulation unit) 51. The external power supply 51 is configured such that the modulation frequency thereof is variable. Therefore, if the modulation frequency is changed by the external power supply 51, the intervals of optical pulses generated by switching are changed. If lights that are differently polarized from each other are divided by the PBS 52, two types of optical pulses that have a particular phase relationship are generated. As in the first embodiment, the two types of optical pulses divided by the PBS 52 are guided to an object such as a photoconductive element by SMFs 54a and 54b, optical amplifiers 55a and 55b, and dispersion compensation units 56a and 56b, respectively. By changing the modulation frequency of the external power supply 51, a difference between a moment of the pump light incident on the object and a moment of the probe light incident on the object changes.

In this embodiment, since the two types of optical pulse strings that have a certain phase difference therebetween are generated by modulating the light source 50, the PBS 52 as a dividing unit is a passive component. Therefore, a driving system can be simplified, which is advantageous. In this embodiment, the polarization direction of light emitted from the light source 50 is modulated as the oscillation state of the light source 50. However, the wavelength of the light emitted from the light source 50 may be modulated instead. In that case, a laser that can change the wavelength thereof may be used as the light source 50 and a dichroic mirror may be used instead of the PBS.

### Third Embodiment

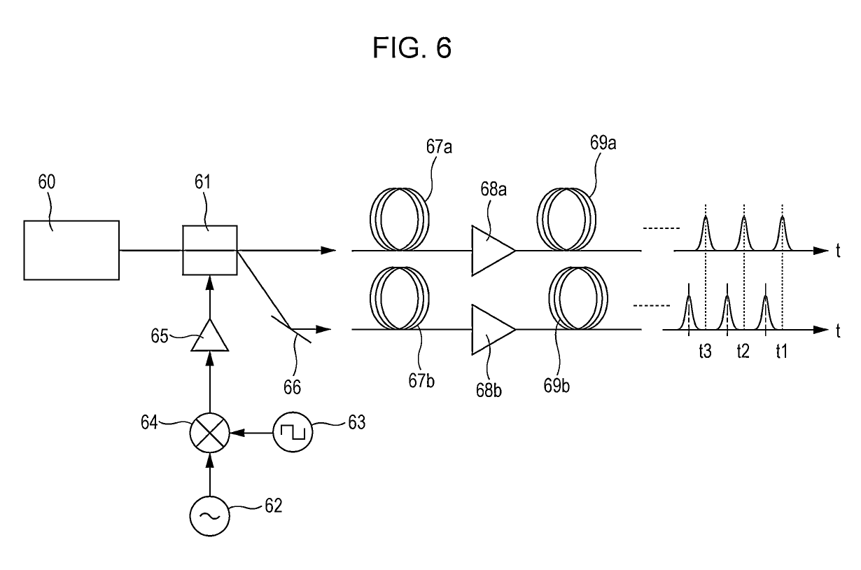

A third embodiment of the present invention is illustrated in FIG. 6. A modulation unit according to this embodiment has an acousto-optic modulator (AOM) 61 instead of the EO modulator according to the first embodiment, as well as a digital signal source 63 that turns on and off a radio frequency (RF) signal 62 to be applied to the AOM 61, a mixer modulator 64, an amplifier 65, and a mirror 66. When the modulation unit according to this embodiment turns on and off the RF signal 62 to be applied to the AOM 61 with the digital signal source 63, the output direction of optical pulses are switched, thereby generating pump light and probe light. As a seed laser 60, a continuous-wave laser diode or a fiber laser may be used as in the first embodiment.

The AOM 61 is a modulator that generates a surface acoustic wave on an acousto-optic element when the RF signal 62 is applied thereto and that outputs incident light that has been deflected from the travel direction due to diffraction. The direction of deflection depends on the frequency of the RF signal 62. Zero-order light when the RF signal 62 is not applied is used as the pump light, and first-order diffracted light that has been deflected upon application of the RF signal 62 is used the probe light. The pump light and the probe light are used as two types of optical pulse signal strings that pass through SMFs 67a and 67b. At this time, turning on and off of the RF signal 62 is controlled by the digital signal source 63 that outputs digital signals and the mixer modulator 64.

Therefore, when the seed laser 60 is continuous light, pulses that reflect the waveform of the digital signal source 63 appear as two types of optical outputs of the AOM 61. After that, through waveform shaping performed by the SMFs 67a and 67b, optical amplification performed by optical amplifiers 68a and 68b, and dispersion compensation performed by dispersion compensation units 69a and 69b, the pump light and the probe light can be generated as the two types of optical pulse signal strings that have a certain phase difference therebetween.

Typically, the frequency of the RF signal 62 is about 2 GHz and the repeated modulation frequency of the digital signal source 63 is 250 Mhz during operation, but the modulation may be performed at higher frequencies.

If the modulation frequency is gradually changed, the pulse intervals of the pump light and the probe light also gradually change, thereby changing the time difference between the two types of pulse strings in the same principle as in the first embodiment.

### Fourth Embodiment

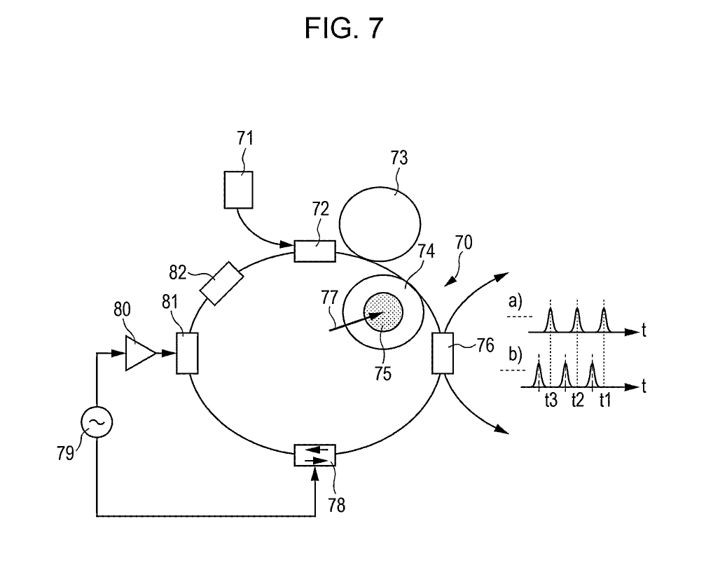

In a fourth embodiment of the present invention, a ring laser is used as a light source having optical output that has been modulated and divided. In this embodiment, a ring-type fiber laser 70 illustrated in FIG. 7 is used as the ring laser. The ring-type fiber laser 70 has a fiber amplifier 73, a dispersion-shifted fiber (DSF) 74, a coupler 76, direction switching isolators 78, an amplifier 80, a strength modulator 81, a filter 82, an excitation laser 71, and a wavelength division coupler 72. By performing modulation while providing gain with the fiber amplifier 73 and synchronizing with the propagation time of circulating light in the ring with the strength modulator 81, oscillation in forced mode locking can be performed. The period of mode locking is determined by an external power supply 79 as a modulation unit, and a part of the DSF 74 is wound with a piezoelectric element (PZT) 75 in order to allow the period to be variable. The length of a resonator can be changed by application of voltage. Therefore, if the frequency of the external power supply 79 is to be changed, the frequency is changed by also synchronizing with voltage 77 to be applied to the PZT 75.

The direction switching isolators 78 are two isolators in different directions, and the oscillation/circulation direction (oscillation state), which is a direction in which laser oscillates, can be selected by selecting either isolator through switching of the optical path. In the case of sinusoidal modulation, for example, by selecting the clockwise circulation with a positive amplitude or the counterclockwise circulation with a negative amplitude while the switching is synchronized with the external power supply 79, output a) or b) of the coupler 76 that are inverse to each other can be obtained as illustrated in FIG. 7.

Amplification and dispersion compensation of pulses in the subsequent stages may be performed as necessary as in the above-described embodiments. In addition, the method of asynchronous sampling in which the time difference between the pump light and the probe light is changed by changing the period of optical pulses is the same as in the above-described embodiments.

By using the ring-type fiber laser 70, optical pulses that generate smaller timing jitter therebetween can be provided. It is to be noted that, although the coupler 76 is used as a dividing unit in this embodiment, micro-electro-mechanical systems (MEMS) may be used as a dividing unit that divides the light propagation direction.

It is to be understood that, although the exemplary embodiments of the present invention have been described above, the present invention is not limited by these embodiments and may be modified or altered in various ways within the scope thereof. For example, the optical pulse generating apparatus in the present invention may be used as a light source of a pump-probe measuring apparatus. In the pump-probe measuring apparatus, the optical pulse generating apparatus in the present invention changes the difference between a moment at which pump light of the pump light incident on an object and a moment of the probe light incident on the object to be measured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-191321, filed Aug. 27, 2010, which is hereby incorporated by reference herein in its entirety.

### REFERENCE SIGNS LIST

1 light source
2 modulator (modulation unit)
3 external power supply (modulation unit)
4, 5 fiber
6a, 6b single mode fiber
7a, 7b optical amplifier
8a, 8b dispersion compensation unit

1. An optical pulse generating apparatus that supplies pump light and probe light, the optical pulse generating apparatus comprising:
a light source; and
a modulation unit configured to modulate light emitted from the light source, thereby dividing the light into the pump light and the probe light,
wherein the modulation unit is configured such that a frequency for modulating the light is variable, and
wherein the modulation unit changes a difference between a moment of the pump light incident on an object and a moment of the probe light incident on the object by changing the frequency.

2. The optical pulse generating apparatus according to claim 1,
wherein the modulation unit includes an electro-optical modulator or acousto-optic modulator, and
wherein the modulation unit divides the light into the pump light and the probe light by performing binary modulation on the electro-optical modulator or the acousto-optic modulator.

3. The optical pulse generating apparatus according to claim 2,
wherein the modulation unit includes a power supply,
wherein the electro-optical modulator is a Mach-Zehnder modulator, and
wherein the modulation unit divides the light into the pump light and the probe light by performing on-off keying on the electro-optical modulator using the power supply.

4. The optical pulse generating apparatus according to claim 2,
wherein the modulation unit includes a digital signal source that turns on and off a radio frequency signal to be applied to the acousto-optic modulator, and
wherein the modulation unit divides the light into the pump light and the probe light by turning on and off the radio frequency signal to be applied to the acousto-optic modulator using the digital signal source.

5. An optical pulse generating apparatus that supplies pump light and probe light, the optical pulse generating apparatus comprising:
a light source;
a modulation unit configured to modulate an oscillation state of the light source; and
a dividing unit configured to divide light emitted from the light source into the pump light and the probe light,
wherein the modulation unit is configured such that a frequency for modulating the oscillation state is variable, and
wherein the modulation unit changes a difference between a moment of the pump light incident on an object and a moment of the probe light incident on the object by changing the frequency.

6. The optical pulse generating apparatus according to claim 5,
wherein the light source is a polarization modulation laser,
wherein the modulation unit changes a polarization direction of the polarization modulation laser, and
wherein the dividing unit is a polarizing beam splitter.

7. An optical pulse generating apparatus that supplies pump light and probe light, the optical pulse generating apparatus comprising:
a light source; and
a modulation unit configured to modulate an oscillation state of the light source,
wherein the light source includes a dividing unit that divides light such that the light source outputs the pump light and the probe light,
wherein the modulation unit is configured such that a frequency for modulating the oscillation state is variable, and
wherein the modulation unit changes a difference between a moment of the pump light incident on an object and a moment of the probe light incident on the object by changing the frequency.

8. The optical pulse generating apparatus according to claim 7,
wherein the light source is a ring laser,
wherein the modulation unit changes a circulation direction of the ring laser, and
wherein the dividing unit is a coupler.

9. The optical pulse generating apparatus according to claim 1, further comprising:
a first optical amplifier configured to amplify the pump light;
a first dispersion compensation unit configured to condense the pump light that has been amplified by the first optical amplifier;
a second optical amplifier configured to amplify the probe light; and
a second dispersion compensation unit configured to condense the probe light that has been amplified by the second optical amplifier.

10. The optical pulse generating apparatus according to claim 1,
wherein the modulation unit changes a difference between a moment of the pump light incident on a terahertz wave generating element and a moment of the probe light incident on a terahertz wave detecting element by changing the frequency.

11. The optical pulse generating apparatus according to claim 1,
wherein the modulation unit changes a difference between a moment of the pump light incident on an object and a moment of the probe light incident on the object to be measured by changing the frequency.

12. A terahertz spectroscopy apparatus comprising:
the optical pulse generating apparatus according to claim 1;
a terahertz wave generating element configured to be irradiated by the pump light emitted by the optical pulse generating apparatus; and
a terahertz wave detecting element configured to be irradiated by the probe light emitted by the optical pulse generating apparatus.

13. A tomography apparatus comprising:
the optical pulse generating apparatus according to claim 1;
a terahertz wave generating element configured to be irradiated by the pump light emitted by the optical pulse generating apparatus; and
a terahertz wave detecting element configured to be irradiated by the probe light emitted by the optical pulse generating apparatus.

14. A terahertz spectroscopy apparatus comprising:
the optical pulse generating apparatus according to claim 5;
a terahertz wave generating element configured to be irradiated by the pump light emitted by the optical pulse generating apparatus; and
a terahertz wave detecting element configured to be irradiated by the probe light emitted by the optical pulse generating apparatus.

15. A tomography apparatus comprising:
the optical pulse generating apparatus according to claim 5;
a terahertz wave generating element configured to be irradiated by the pump light emitted by the optical pulse generating apparatus; and
a terahertz wave detecting element configured to be irradiated by the probe light emitted by the optical pulse generating apparatus.

16. A terahertz spectroscopy apparatus comprising:
the optical pulse generating apparatus according to claim 7;
a terahertz wave generating element configured to be irradiated by the pump light emitted by the optical pulse generating apparatus; and
a terahertz wave detecting element configured to be irradiated by the probe light emitted by the optical pulse generating apparatus.

17. A tomography apparatus comprising:
the optical pulse generating apparatus according to claim 7;
a terahertz wave generating element configured to be irradiated by the pump light emitted by the optical pulse generating apparatus; and
a terahertz wave detecting element configured to be irradiated by the probe light emitted by the optical pulse generating apparatus.
